(19) United States
(12) Patent Application Publication
(10) Pub. No.: US 2009/0163314 A1
(43) Pub. Date: Jun. 25, 2009

(54) TRANSMISSION DEVICE FOR DISTRIBUTING A DRIVE TORQUE TO AT LEAST TWO OUTPUT SHAFTS

(75) Inventors: Alois Böck, Hutthurm (DE); Detlef Baasch, Friedrichshafen (DE); Gerhard Gumpoltsberger, Friedrichshafen (DE); Thomas Rosemeier, Meckenbeuren (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 12/299,643

(22) PCT Filed: Apr. 16, 2007
(86) PCT No.: PCT/EP07/53664

§ 371 Date: Nov. 5, 2008

(30) Foreign Application Priority Data
May 12, 2006 (DE) 10 2006 022 176.1

(51) Int. Cl. F16H 48/06; F16H 48/22

(52) U.S. Cl. 475/248; 475/249

(57) ABSTRACT

A transmission device for distributing drive torque to two output shafts, including a differential with a driven differential cage. The outputs are connected to the differential, in which, between the differential cage and the output of one side, viewed in the direction of the flow of force, two plus-planetary gear trains are arranged adjacent and co-axial with the output. The gear trains have first and second sun gears, first and second planetary ranges with the first sun gear being connected to the differential and the second sun gear being connected with the first sun gear and the output. The segment of the planetary gear for actuating the transmission device or transferring torque is able to be braked and the segment of the planetary gear train reversing drive is coupled via a switching element to the transmission housing.

This application is a national stage completion of PCT/EP2007/053664 filed Apr. 16, 2007, which claims priority from German Application Serial No. 10 2006 022 176.1 filed May 12, 2006.

### FIELD OF THE INVENTION

The invention relates to a transmission device for distributing drive torque to at least two output shafts.

### BACKGROUND OF THE INVENTION

These kinds of transmission devices or variable ratio gear units, are used to shift torques between the wheels of an axle in motor vehicles. In order to do this, in addition to the differential proper, there are corresponding devices or superpositioning units where, for each transmission direction, a multiple-disc clutch is provided.

From the Applicant's DE 103 48 959 A1, a transmission device is known for shifting a drive torque to at least two output shafts with at least two, at least triple-shaft planetary gear trains, where the planetary gear trains serve as differentials. Here, in each case, one shaft of a planetary gear train is connected to one output shaft and a second shaft of a planetary gear train in each case with one of the output shafts. Furthermore, a third shaft of the planetary gear trains is functionally connected to a brake in such a way that a degree of distribution between the two output shafts varies subject to the transmission capacities of the brakes. DE 103 48 959 A1 additionally describes a method of controlling and regulating the known transmission device in which, in order to distribute a drive torque of a drive unit between the two output shafts of the transmission device, the transmission capacities of the two brakes are adjusted in such a way that one brake has a synchronous state and the transmission capacity of the other brake is varied between a lower threshold value and an upper threshold value that corresponds to an engaged state of the brakes.

The Applicant's DE 103 48 960 A1 also describes a transmission device for distributing the drive torque to at least two output shafts with at least two, at least triple-shaft planetary gear trains, where the planetary gear trains serve as differentials and where, in each case, one shaft of a planetary gear train is connected to one drive shaft. Furthermore, in each case, one shaft of a planetary gear train represents one of the output shafts where, in each case, at least one additional shaft of a planetary gear train has a functional connection to a shaft of an additional planetary gear train. In this connection, a torque of a shaft that depends on the operating state, subject to an operating state of the other shaft that is functionally connected to it, can be reinforced via the functional connection in such a way that when there is a difference in rotational speed between the output shafts, a torque that changes the rotational speed is applied to the planetary gear trains by way of the functional connection.

German published patent application 2 017 716 describes a steering gear for a tracked vehicle, in particular for snow cats, consisting of a drive pinion, a differential ring gear that is engaged with it and fixedly connected to an inner transmission housing, as well as compensation gears rotatably mounted inside the housing and at least two output shafts. A second differential transmission is superimposed on this known differential transmission, where one or the other side of the superimposed differential can be completely or partially braked.

In addition, a differential transmission is known from DE 697 10 033 T2, comprising a rotatable component on the input side for receiving an external drive force, two rotatable components on the output side that are arranged co-axially with the axis of rotation of the input-side rotatable component, a transmission housing in which the input-side component and the output-side components are arranged to freely rotate, where a torsional force of the input-side rotatable component is transferred to the output-side rotatable component, while a different torque is allowed between the output-side rotatable components.

Moreover, this differential transmission comprises a first input-side gear wheel that is mounted on the axial end of an input-side, rotatable component that is rotatable together with the input-side, rotatable component; a second input-side gearwheel that is deposed on the input-side, rotatable component and is rotatable together with this component; a first output-side, gear wheel with a deceleration ratio that is greater or smaller in relation to the first input-side, gear wheel, whereby the first output-side gear wheel is rotatable together with the output-side, rotatable component; a second output-side gear wheel with a deceleration ratio that is smaller or greater in relation to the second input-side, gear wheel, and at least one planetary gear that meshes with the first input-side, gear wheel and the first output-side, gear wheel, and at least one second planetary gear that meshes with the second input-side, gear wheel and the second output-side, gear wheel.

In the transmission, according to DE 697 10 033 T2, the second input-side, gear wheel is arranged on an axial end of the input-side, rotatable component, where the second output-side, gear wheel is co-axially rotatable with one of the output-side, rotatable components. In addition, the differential transmission features a carrier that supports the first planetary gear and the second planetary gear in such that they can rotate around their own axes and rotate around the axis of rotation of the input-side, rotatable component.

Furthermore, a first rotation control is provided for controlling the rotation of the carrier around the axis of rotation of the input-side, rotatable component with any desired control force and with a second rotation control to control the rotation of the second output-side, gear wheel with arbitrary control force, where the rotation controls comprise a plurality of friction surfaces, which are rotatable together with the carrier or the second output-side, gear wheel, as well as a plurality of friction surfaces that are rotatable together with the housing. Furthermore, pressure media are provided for compressing the friction surfaces with an arbitrary compressive force. This known transmission disadvantageously comprises a large number of components, and the manufacturing and installation costs are high.

The present invention is based on the objective of disclosing a transmission device for distributing a drive torque to at least two output-shafts, including a differential that is simply constructed and features a multiple-disc clutch or a brake for both transmission directions.

### SUMMARY OF THE INVENTION

Accordingly, a transmission device for distributing drive torque to at least two output shafts is proposed, including a differential of spur gear construction, such that access to both outputs is possible from one side of the differential.

It is provided within the frame of an advantageous embodiment that two plus planetary gear trains (first planetary gear train, second planetary gear train) are arranged, one after the other, between the differential cage and the output of one side, viewed from the direction of the flow of force, preferably co-axially to the output Ab2. The first planetary gear train comprises a first sun gear, a second sun gear, a first planetary range and a second planetary range, where the second planetary gear train comprises a first sun gear, a second sun gear, a first planetary range and a second planetary range.

The first sun gear of the first planetary gear train is connected to the differential and is driven by it, where the second sun gear of the first planetary gear train is connected by way of a shaft with the first sun gear of the second planetary gear train. Furthermore, the second sun gear of the second planetary gear train is connected to the output Ab2. In accordance with the invention, the segment of the second planetary gear train can be regularly braked or coupled to a housing of the transmission in order to actuate the transmission device or to transfer a torque that can be regulated, where the segment of the first planetary gear train can be coupled to a housing G of the transmission device by means of a switching element, preferably by way of a claw coupling, in order to realize reverse multiplication.

In a further embodiment of the invention, a countershaft is provided between the differential cage and the output of one side, which countershaft features different reduction stages and is connected to the differential on the drive side where, on the drive side, the countershaft can be connected by way of a switching element, via one of the gear ratios, with a shaft that can be regularly connected to the output by way of an electromechanically or hydraulically actuatable, multiple disc-clutch for actuating the transmission device or for transferring a controlled torque that can be regulated.

The invention is described in more detail below on the basis of the appended Figures, wherein

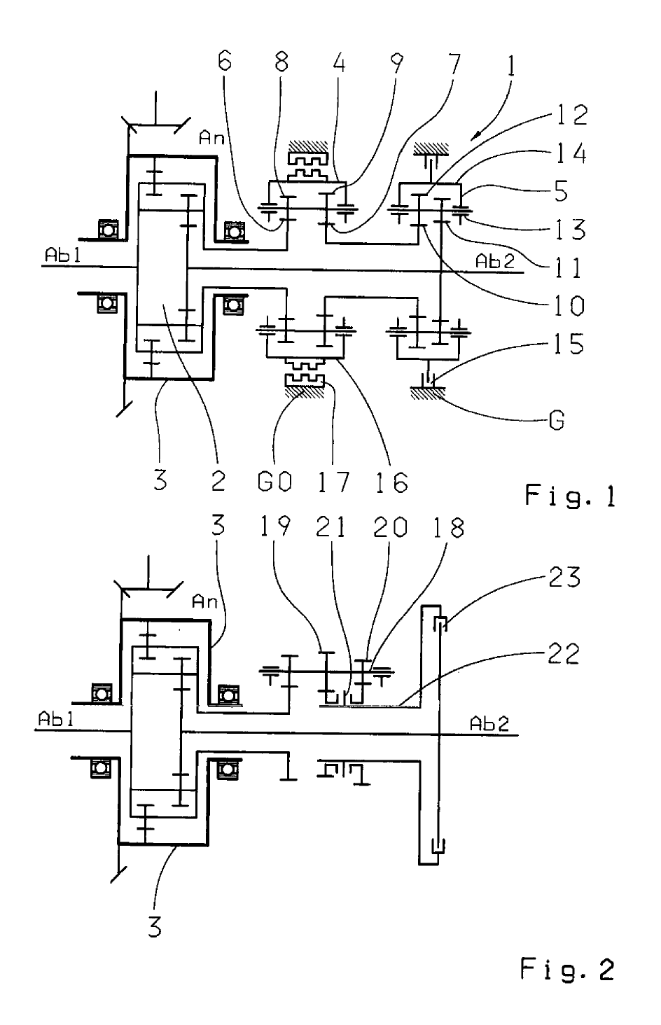

FIG. 1 is a schematic view of a first embodiment of the invention in which two plus planetary gear trains, arranged one after the other co-axially to the output, are provided between the differential cage of the differential and the output of one side viewed from the direction of the flow of force, and

FIG. 2 is a schematic view of a first embodiment of the invention in which a countershaft is arranged between the differential cage and the output of one side.

Referring to FIG. 1, a transmission device 1 of the invention includes a differential 2 with a spur gear construction with meshing double planetary gears with a differential cage 3 driven by a drive input unit An, where the drive output units Ab1 and Ab2 are connected to the differential 2. As can be seen from the Figure, between the differential cage 3 and the output Ab2 of one side, viewed in the direction of the flow of force, two plus planetary gear trains 4, 5 are arranged co-axially to the output Ab2. The planetary gear train 4 comprises a first sun gear 6, a second sun gear 7, a first planetary range 8 and a second planetary range 9. The planetary gear train 5 comprises a first sun gear 10, a second sun gear 11, a first planetary range 12 and a second planetary range 13.

Here, the first sun gear 6 of the planetary gear train 4 is connected to the differential 2 and is driven by it, whereas the second sun gear 7 of the planetary gear train 4 is connected to the first sun gear 10 of the planetary gear train 5. Furthermore, the second sun gear 11 of the planetary gear train 5 is connected to the output Ab2. In accordance with the invention, a segment 14 of the planetary gear train 5 for actuating the transmission device 1 can be regularly braked or coupled by way of a brake 15 to a housing G of the transmission device 1. Furthermore, a segment 16 of the planetary gear train 4 for realizing a reverse multiplication can preferably be connected by way of a claw coupling 17 to a housing G of the transmission device 1.

In the embodiment shown in FIG. 2, a countershaft 18 is provided between the differential cage 3 and the output Ab2. The countershaft featuring different reduction stages 19, 20. The countershaft 18 is connected to the differential 2 on the drive side where, on the output side, it can be connected by way of a switching element 21 via one of the reduction stages with a shaft 22, which can be detachably connected to the output Ab2 by way of an electromechanical or hydraulically actuatable, multiple-disc clutch 23 for actuating the transmission 1. By actuating the switching element 21, the reduction stage or the transmission direction can be selected.

Obviously, any constructional formation, in particular any spatial arrangement of the components of the transmission device of the invention as such or in relation to one other and, as far as technically reasonable, falls under the extent of protection of the present claims without influencing the functioning of the transmission device, as disclosed in the claims, even if these embodiments are not explicitly presented in the Figures or the description.

### REFERENCE NUMERALS

1 transmission device
2 differential
3 differential cage
4 planetary gear train
5 planetary gear train
6 first sun gear of the planetary gear train 4
7 second sun gear of the planetary gear train 4
8 first planetary range of the planetary gear train 4
9 second planetary range of the planetary gear train 4
10 first sun gear of the planetary gear train 5
11 second sun gear of the planetary gear train 5
12 first planetary range of the planetary gear train 5
13 second planetary range of the planetary gear train 5
14 segment of the planetary gear train 5
15 brake
16 segment of the planetary gear train 4
17 claw coupling
18 countershaft
19 reduction stage
20 reduction stage
21 switching element
22 shaft
23 multiple-disc clutch
G housing
An drive unit
Ab1 output
Ab2 output

1-4. (canceled)

5. A transmission device for distributing drive torque to at least first and second output shafts (Ab1, Ab2), the transmission device comprising a differential (2) of spur gear construction with a drive unit (An) driven by a differential cage (3), whereby the first and the second output shafts (Ab1, Ab2) are connected to the differential (2), first and second plus planetary gear trains (4, 5) are arranged, one after the other, co-axially in relation to the second output shaft (Ab2) between the differential cage (3) and the second output shaft (Ab2) on one side, when viewed in a direction of the flow of force, each of the first and the second planetary gear trains (4, 5) respectively includes a first sun gear (6, 10), a second sun gear (7, 11), a first planetary range (8, 12) and a second planetary range (9, 13), the first sun gear (6) of the first planetary gear train (4) is connected to the differential (2) and the second sun gear (7) of the first planetary gear train (4) is connected to the first sun gear (10) of the second planetary gear train (5), the second sun gear (11) of the second planetary gear train (5) is connected to the second output shaft (Ab2), a segment (14) of the second planetary gear train (5) is connectable to a housing (G) of the transmission device (1) by way of a brake (15) for at least one of actuating the transmission device (1) and transferring a torque and a segment (16) of the second planetary gear train (4) is connectable to the housing (G) of the transmission device (1) by way of a switching element (17) for a reverse gear ratio.

6. The transmission device for distributing a drive torque to at least the first and second output shafts (Ab1, Ab2) according to claim 5, wherein the switching element (17) is a claw coupling.

7. A transmission device for distributing drive torque to at least first and second output shafts (Ab1, Ab2), the transmission device comprising a differential (2) in spur gear construction with a differential cage (3) driven by a drive unit (An), the first and the second output shafts (Ab1, Ab2) are connected to the differential (2), wherein a countershaft (18) is provided between the differential cage (3) and the second output shaft (Ab2), one side of the countershaft (18) is connected with the differential (2) on a drive side, the countershaft (18) having different reduction stages (19, 20), and the countershaft (18), on an output side, is connectable by way of a switching element (21) with a further shaft (22) by way of one of the reduction stages (19, 20), the further shaft (22) is detachably connected to the second output shaft (Ab2) by a multiple-disc clutch (23) to one of actuate the transmission device (1) and transfer a torque that is regulated.

8. The transmission device for distributing a drive torque to at least the first and second output shafts (Ab1, Ab2) according to claim 7, wherein the multiple-disc clutch (23) is actuated one of electromechanically or hydraulically.

9. A transmission device for distributing drive torque, the transmission device comprising:
a spur gear differential (2) having a differential cage (3) coupled to a drive unit (An), first and second outputs (Ab1, Ab2) are connected to the differential (2) such that drive torque is transferred from the drive unit (An), via the differential, to the first output (Ab1) and the second output (Ab2);
first and second plus planetary gear trains (4, 5) are located axially adjacently, in a flow of force, between the differential cage (3) and the second output (Ab2);
each of the first planetary gear train (4) and the second planetary gear train (5) have a first sun gear (6, 10), a second sun gear (7, 11), a first planetary gear (8, 12) and a second planetary gear (9, 13);
the first sun gear (6) of the first planetary gear train (4) is connected to the differential (2);
the second sun gear (7) of the first planetary gear train (4) is connected to the first sun gear (10) of the second planetary gear train (5),
the second sun gear (11) of the second planetary gear train (5) is connected to the second output (Ab2),
a segment (14) of the second planetary gear train (5) is connectable, via a brake (15), to a housing (G) of the transmission device (1) for at least one of actuating the transmission device (1) and controlling drive torque transferred from the drive unit (An); and
a segment (16) of the first planetary gear train (4) is connectable, via a switching element (17), to a housing (G) of the transmission device (1) for reversing the drive torque transferred from the drive unit (An).
